(19) United States
(12) Patent Application Publication
(10) Pub. No.: US 2010/0055329 A1
(43) Pub. Date: Mar. 4, 2010

(54) SURFACE TREATMENT METHOD FOR PLASTIC ARTICLES

(75) Inventors: CHWAN-HWA CHIANG, Shindian (TW); CHUN-MAN HON, Shindian (TW)

Correspondence Address: PCE INDUSTRY, INC.;ATT. Steven Reiss, 288 SOUTH MAYO AVENUE, CITY OF INDUSTRY, CA, 91789, US

(73) Assignee: FIH (Hong Kong) Limited, Kowloon (HK)

(21) Appl. No.: 12/542,820

(22) Filed: Aug. 18, 2009

(30) Foreign Application Priority Data
Sep. 3, 2008 (CN) 200810304363.9

(51) Int. Cl. B05D 1/36; B05D 1/38

(52) U.S. Cl. 427/296

(57) ABSTRACT

A surface treatment method for plastic articles, comprising: molding a substrate to form a roughened region on a surface of the substrate; forming a base paint coating on the surface of the substrate having the roughened region; forming a vacuum coating with metallic appearance on the base paint coating; forming a middle paint coating on the vacuum coating; and forming a top paint coating on the middle paint coating.

### CROSS-REFERENCE TO RELATED APPLICATIONS

This application is one of the three related co-pending U.S. patent applications listed below. All listed applications have the same assignee. The disclosure of each of the listed applications is incorporated by reference into all the other listed applications.

| | Attorney | | | |
|---|---|---|---|---|
| Application | Docket | | | Filing |
| Number: | No. | Title | Inventors | date |
| — | US22308 | SURFACE TREATMENT METHOD | CHWAN-HWA | — |
| | | FOR PLASTIC ARTICLES | CHIANG et al. | |
| 12/536,300 | US22357 | PROCESS FOR SURFACE | CHWAN-HWA | Aug. 5, |
| | | TREATING PLASTIC SUBSTRATE | CHIANG et al. | 2009 |
| 12/538,270 | US23420 | DEVICE HOUSING AND METHOD | Qin-Zheng | Aug. 10, |
| | | FOR MAKING THE SAME | Hou et al. | 2009 |

### BACKGROUND

1. Technical Field

The present disclosure relates to surface treatment methods for plastic articles, especially to a method for forming metallic coatings on plastic articles.

2. Description of Related Art

Electroplating is a typical method used to form a metallic coating on plastic articles to give the plastic article a metallic appearance. However, electroplating is not environmental friendly and requires additional costly and time consuming processes to treat wastewater. Furthermore, the metallic coating formed on the plastic article by electroplating cannot present an appearance of different levels of gloss at different regions of the coating.

Another method for forming a metallic coating on a plastic article is spray painting the plastic article with metallic paint. However, the metallic paint cannot present a real metallic appearance.

Therefore, there is room for improvement within the art.

### DETAILED DESCRIPTION

A surface treatment method for plastic articles may comprise the following steps: molding a substrate to form a roughened region on a surface of the substrate; forming a base paint coating on the surface of the substrate having the roughened region by spray painting; forming a vacuum coating with metallic appearance on the base paint coating; forming a middle paint coating on the vacuum coating by spray painting; and forming a top paint coating on the middle paint coating by spray painting. Each step is described in more detail below.

A substrate is molded in a mold with molten plastic. The plastic may be selected from a group consisting of polycarbonate (PC), acrylonitrile-butadiene-styrene (ABS), and polymethyl methacrylate (PMMA). The mold has a mold cavity with a partial pre-defined roughened surface. Accordingly, the substrate is formed with a corresponding roughened surface on a partial region of the substrate during the molding process.

A base paint coating is formed on the surface of the substrate having the roughened region, e.g., by spray painting. The paint used in the base paint coating may be transparent ultraviolet curing paint. The base paint coating formed on the non-roughened regions of the substrate can improve the smoothness of the non-roughened surface of the substrate. Accordingly, the subsequently formed vacuum coating presents a glossy appearance. The base paint coating formed on the roughened regions of the substrate presents a matte appearance, accordingly, the subsequently formed vacuum coating can have a matte appearance. The base paint coating can improve the adhesion for bonding with the vacuum coating.

A vacuum coating with a metallic appearance is formed on the base paint coating by, e.g., vacuum depositing method or vacuum sputtering method. The material used for the vacuum coating can be a metal or a nonmetal having a metallic appearance. The metal may be indium or tin. The nonmetal may be selected from a group consisting of silicon, silicon-aluminum, and silicon dioxide. The vacuum coating can be nonconductive by choosing the above-mentioned materials and controlling the thickness of the vacuum coating to a range of about 0.01-10 μm.

A middle paint coating is formed on the vacuum coating by, e.g., spray painting. The middle paint coating is transparent or translucent. The paint used in the middle paint coating may be ultraviolet curing paint, polyurethane paint or polyester paint. The middle paint coating may further contain several kinds of pigment to make the coating present colorful appearance.

A top paint coating is formed on the middle paint coating by spray painting. The top paint coating is transparent or translucent. The paint used in the top paint coating may be ultraviolet curing paint, polyurethane paint or polyester paint. The top paint coating has a high rigidity to prevent abrasion or scratching.

It should be understood, prior to each of the forming of the base paint coating, the middle paint coating and the top paint coating, a de-dusting treatment may be implemented.

The exemplary surface treatment method forms a vacuum coating on a plastic article to give the plastic article a metallic appearance. The surface of the plastic article has a pre-formed roughened region, accordingly, the vacuum coating formed on the roughened region of the plastic article can have a matte appearance, which may be, for example, in strong or subtle contrast to the vacuum coating formed on the non-roughened regions of the plastic article. The forming of vacuum coating by vacuum depositing or sputtering method is more efficient. Moreover, the vacuum coating does not block electromagnetic wave and interfere with radio signal.

It should be understood, however, that even though numerous characteristics and advantages of the present embodiments have been set forth in the foregoing description, together with details of functions of the embodiments, the disclosure is illustrative only, and changes may be made in detail within the principles of the disclosure to the full extent indicated by the broad general meaning of the terms in which the appended claims are expressed.

What is claimed is:

1. A surface treatment method for plastic articles, comprising:
molding a substrate to form a roughened region on a surface of the substrate;
forming a base paint coating on the surface of the substrate having the roughened region;
forming a vacuum coating with metallic appearance on the base paint coating;
forming a middle paint coating on the vacuum coating; and
forming a top paint coating on the middle paint coating.

2. The method as claimed in claim 1, wherein at least one of the paint coatings is formed by spray painting.

3. The method as claimed in claim 1, wherein the base paint coating is a transparent ultraviolet curing paint coating.

4. The method as claimed in claim 1, wherein the vacuum coating is a metal coating or a nonmetal coating.

5. The method as claimed in claim 4, wherein the metal coating is indium or tin.

6. The method as claimed in claim 4, wherein the nonmetal coating is silicon, silicon-aluminum, or silicon dioxide.

7. The method as claimed in claim 1, wherein the middle paint coating contains pigments.

8. The method as claimed in claim 1, wherein the middle paint coating is an ultraviolet curing paint coating, a polyurethane paint coating, or a polyester paint coating.

9. The method as claimed in claim 1, wherein the top paint coating is an ultraviolet curing paint coating, a polyurethane paint coating, or a polyester paint coating.

10. The method as claimed in claim 1, wherein prior to each of the forming of base paint coating, the middle paint coating and the top paint coating, a de-dusting treatment is implemented.

11. The method as claimed in claim 1, wherein the molding step is carried out in a mold, the mold has a mold cavity with a partial pre-defined roughened surface.

12. A surface treatment method for plastic articles, comprising:
molding a substrate to form a roughened region on one surface of the substrate;
forming a base paint coating on the surface of the substrate having the roughened region; and
forming a vacuum coating with metallic appearance on the base paint coating.

13. The method as claimed in claim 12, wherein the base paint coating is formed by spray painting.
